(19) United States
(12) Patent Application Publication
(10) Pub. No.: US 2020/0193433 A1
(43) Pub. Date: Jun. 18, 2020

(54) SYSTEM AND METHOD FOR SECURELY PROCESSING VERIFICATION DATA

(71) Applicant: MASTERCARD ASIA/PACIFIC PTE. LTD., SINGAPORE (SG)

(72) Inventors: Wei Ping Philip Yen, Singapore (SG); Rajat Maheshwari, Singapore (SG)

(21) Appl. No.: 16/609,149

(22) PCT Filed: May 8, 2018
(86) PCT No.: PCT/SG2018/050226

§ 371 Date: Oct. 28, 2019

(30) Foreign Application Priority Data
May 9, 2017 (SG) 10201703837P

(51) Int. Cl. G06Q 20/40; G06Q 20/32; G06Q 20/34

(52) U.S. Cl. CPC G06Q 20/401; G06Q 20/34; G06Q 20/3278

(57) ABSTRACT

A system for securely processing verification data and a method of securely processing verification data by a mobile device are provided. The system includes a mobile device including an NFC reader capable of generating an NFC field, and a verification device associated with the mobile device and responsive to the NFC field. A secure NFC channel is established between the mobile device and the verification device. The verification device is configured to receive input from a user and transmit verification data to the mobile device via the secure NFC channel. The verification data includes the input from the user. The NFC reader of the mobile device is further configured to receive the verification data and directly communicate the verification data to a secure component of the mobile device.

### FIELD

The present disclosure relates broadly, but not exclusively, to systems and methods for securely processing verification data.

### BACKGROUND

Mobile computing devices can act as simple and cost-effective payment terminals for electronic transactions, especially for merchants with low volumes or turnovers. Such devices are usually off-the-shelf consumer-grade mobile devices such as tablet computers or smart phones.

In some electronic transactions, cardholder verification data such as a personal identification number (PIN) from the consumer or cardholder may be required to process a payment request. For example, a contactless payment exceeding a pre-set limit may require the PIN to proceed. However, one challenge for entering the PIN on a consumer-grade mobile device is the concern around the security, since payment card industry payment entry device (PCI-PED) compliance is usually not possible on a mobile device.

Some solutions that have been proposed or evaluated have security flaws or are susceptible to hacking or intrusions.

A need therefore exists to provide a system and method for securely processing verification data in an electronic transaction that address at least some of the above problems.

### SUMMARY

According to an aspect of the present disclosure, there is provided a system for securely processing verification data. The system comprises a mobile device including an NFC reader capable of generating an NFC field, and a verification device associated with the mobile device and responsive to the NFC field, wherein a secure NFC channel is established between the mobile device and the verification device. The verification device is configured to receive input from a user and transmit verification data to the mobile device via the secure NFC channel, wherein the verification data includes the input from the user. The NFC reader of the mobile device is further configured to receive the verification data and directly communicate the verification data to a secure component of the mobile device.

The secure component may be a universal integrated circuit card (UICC) of the mobile device.

The secure component may be an embedded security element (eSE) of the mobile device

The secure component may be a trusted execution environment (TEE) of the mobile device.

The verification data may comprise cardholder verification data.

The cardholder verification data may comprise an alphanumeric string, and the verification device may be configured to transmit each element of the alphanumeric string sequentially to the mobile device.

The cardholder verification data may comprise biometric data, and the verification device may comprise a biometric sensor configured to receive biometric input from the user.

The verification device may be configured to transmit the verification data to the mobile device directly without storing any of the verification data on the verification device.

The verification device may comprise a passive NFC device comprising a processor, an NFC chip communicatively coupled to the processor, and an input device communicatively coupled to the processor and configured to receive the input from the user.

According to another aspect of the present disclosure, there is provided a method of securely processing verification data by a mobile device. The method comprises generating, by an NFC reader in the mobile device, an NFC field, establishing a secure NFC channel between the mobile device and a verification device by the verification device responding to the NFC field. The method further comprises receiving, by the verification device, input from a user, securely transmitting verification data from the verification device to the NFC reader via the secure NFC channel, wherein the verification data includes the input from the user, and receiving the verification data, by the NFC reader, and directly communicating the verification data to a secure component of the mobile device.

The secure component may be a universal integrated circuit card (UICC) of the mobile device.

The secure component may be an embedded security element (eSE) of the mobile device.

The secure component may be a trusted execution environment (TEE) of the mobile device.

The method may further comprise associating the verification device with the mobile device prior to establishing the secure NFC channel.

The verification data may comprise cardholder verification data.

The cardholder verification data may comprise an alphanumeric string, and transmitting the verification data may comprise transmitting each element of the alphanumeric string sequentially to the mobile device.

The cardholder verification data may comprise biometric data, and receiving the input from the user may comprise receiving biometric input from the user.

Securely transmitting the verification data from the verification device to the mobile device may comprise transmitting directly without storing any of the verification data on the verification device.

The method may comprise terminating the secure NFC channel upon the mobile device detecting an NFC device different from the verification device.

### BRIEF DESCRIPTION OF THE DRAWINGS

Embodiments of the present disclosure will be better understood and readily apparent to one of ordinary skill in the art from the following written description, by way of example only, and in conjunction with the drawings, in which:

FIG. 1 shows a schematic block diagram illustrating a system for securely processing verification data according to an example embodiment

FIG. 2 shows a schematic block diagram illustrating a verification device according to an example embodiment.

FIG. 3 shows a schematic block diagram illustrating possible data flows within a mobile device according to an example embodiment.

FIG. 4 shows a detailed flow chart illustrating use of the system of FIG. 1 in an electronic transaction according to an example embodiment.

FIG. 5 shows a flow chart illustrating a method for securely processing verification data according to an example embodiment.

FIG. 6 shows a schematic block diagram of a wireless device suitable for implementing example embodiments of the method and system according to an example embodiment.

### DETAILED DESCRIPTION

The example embodiments provide systems and methods for securely processing verification data, including but not limited to cardholder verification data such as a personal identification number (PIN) or biometric data, during an electronic transaction. Currently, many merchants accept electronic payment transactions as an alternative to cash for the payment for products or services. In such electronic payment transactions, a payment card may be used. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. In other words, in some instances, such a payment card may not exist in a physical form, but rather, may be in an electronic form comprising data stored in an electronic device.

Typically, in an electronic transaction, when a payment card holder (hereinafter also referred to as a consumer) wishes to purchase a product/service from a merchant, the payment card holder presents his/her payment card to the merchant. The merchant then submits a payment request to an acquirer (e.g. a financial institution such as a bank that processes the merchant's transactions). The acquirer then sends the request to the issuer (a financial institution, bank, credit union or company that issues or helps issue cards to payment card holders) to authorize the transaction. A payment network (e.g. MasterCard®) links the acquirer and the issuer and facilitates the authorization, clearing, and settlement of the transaction. The verification data may be required by the issuer for verification before the issuer processes the payment request. For example, if a transaction amount exceeds a limit set by the Cardholder Verification Method (CVM), the consumer will be prompted to provide additional information, which will be used in the cardholder verification data.

As used herein, “verification data” may refer to any type of data used to authenticate whether a card holder is a legitimate user of that card being used by the card holder. Typically, such data is transmitted together with a payment request and the issuer can determine whether the verification data matches with the data on record, e.g. stored in a database maintained by the issuer. A non-limiting example of verification data is cardholder verification data, which may be in the form of an alphanumeric string (e.g. PIN, password, keypad pattern) or biometric data (e.g. fingerprint, iris, facial pattern).

The example embodiments will now be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those having ordinary skill in the data processing arts to convey most effectively the substance of their work to others of ordinary skill in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or in other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines or devices may be used with programs in accordance with the teachings herein. Alternatively, the construction of more specialized apparatus to perform the required method steps may be appropriate. The structure of a suitable computing device will appear from the description below.

In addition, the present specification also implicitly discloses a computer program, in that it would be apparent to the person of ordinary skill in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer or other suitable computing device. The computer readable medium may also include a hard-wired medium such as exemplified in the Internet system, or wireless medium such as exemplified in the GSM, GPRS, 3G or 4G mobile telephone systems, as well as other wireless systems such as Bluetooth, NFC, ZigBee, Wi-Fi. The computer program when loaded and executed on such a computer effectively results in an apparatus that implements the steps of the preferred method.

Example embodiments of the present invention may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC) or Field Programmable Gate Array (FPGA). Numerous other possibilities exist. Those of ordinary skill in the art will appreciate that the system can also be implemented as a combination of hardware and software modules.

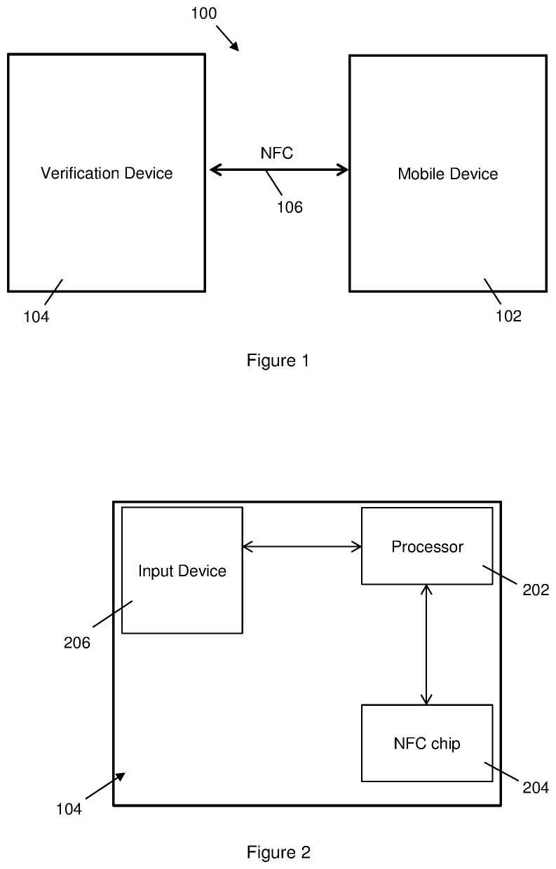

FIG. 1 shows a schematic block diagram illustrating a system 100 for processing verification data according to an example embodiment. The system 100 includes a mobile device 102 and a verification device 104 associated with the mobile device 102. For example, the verification device 104 is registered with the mobile device 102 such that the mobile device 102 can uniquely identify the verification device 104. In preferred embodiments, the mobile device 102 has a near field communication (NFC) chip that generates an NFC field, while the verification device 104 is a passive NFC device that is responsive to the NFC field for establishing a secure NFC channel 106 with the mobile device 102. The verification device 104 can receive verification data input from a user and securely transmit the verification data to the mobile device 102 via the secure NFC channel 106. The mobile device 102 can receive the verification data and securely communicate the verification data within the mobile device 102. For example, the NFC chip of the mobile device 102 receives the verification data and communicates the verification data to a secure component of the mobile device 102.

The system 100 can provide a secure way of processing verification data from the time the input is provided by the user to the time the verification data is further processed within the mobile device 102. As will be described in further details below, safeguards are provided to improve security such that the user can be assured that sensitive information is not stored, manipulated or intercepted. For example, the verification data is directly transmitted from the verification device 104 to the mobile device 102 without any of the data being stored on the verification device 102. The communication between the verification device 104 and the mobile device 102 may be encrypted. The mobile device 102 can also terminate the transmission if an intrusion is detected. Within the mobile device 102, the verification data is only communicated to designated secure components.

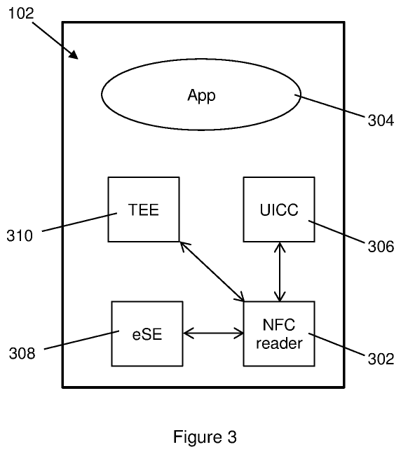

FIG. 2 shows a schematic block diagram illustrating the verification device 104 of FIG. 1 according to an example embodiment. The verification device 104 includes a processor 202, an NFC chip 204 communicatively coupled to the processor 202, and an input device 206 communicatively coupled to the processor 202. The input device 206 is configured to receive verification data, e.g. a 4-digit or 6-digit PIN, password, or biometric data, from a user. The processor 202 is configured to control the NFC chip 204 to establish a secure connection with an NFC reader (shown in FIG. 3) of the mobile device 102 (FIG. 1) and transmit the verification data to the NFC reader.

In an example where a user PIN is required, the input device 206 may be implemented as a pad with physical buttons. However, other forms, such as a dial or a touch screen, may be possible. In some implementations, feedback in the form of tactile or haptic responses, vibrations, sounds or lights, may be provided to indicate that a button has been pressed, i.e. a digit of the PIN has been entered. The input device 206 may also include a small display to the PIN entry progress while masking the actual digits, for example, a display showing “****”. The input device 206, NFC chip 204 and processor 202 can be integrated into a compact form that can be part of the flap cover that moves in and out of the NFC field of the mobile device 102 depending on the mode of operation. Alternatively or in addition, where biometric data is required, the input device 206 may include a biometric sensor, such as a fingerprint sensor, an iris scanner, etc., configured to receive biometric data from the consumer.

In preferred embodiments, the verification device 104 is configured to transmit the verification data to the mobile device 102 directly transmitting without storing any of the verification data. For example, the verification device 104 does not include a memory unit, thereby eliminating the possibility of the card verification data being stored on the verification device 104. As a result, when implemented for PIN entry, PCI-PED compliance may be improved compared to existing solutions. Furthermore, in some embodiments, the verification data may be transmitted sequentially in encrypted blocks or packets, instead of the complete verification data at once, and the possibility of the data being successfully intercepted by a third party may be substantially reduced. For example, the verification data 100 can send a PIN to a compatible mobile device digit by digit in a secure manner.

The verification device 104 in this example is a passive NFC device that is configured to switch on and be powered by a magnetic field of a compatible active NFC reader. This configuration may provide more security against interception attacks than an active NFC device that allows two-way data exchange with the NFC reader. Typically, NFC works using magnetic induction, where the reader device emits a small electric current which creates a magnetic field that in turn bridges the physical space between the devices. That field is received by a similar coil in the passive NFC device where it is turned back into electrical impulses to communicate data such as identification number status information or any other information. So-called “passive” NFC tags use the energy from the reader to encode their response.

In at least some embodiments, the communication between the verification device 104 and the mobile device 102 is performed in a secure communication mode where the verification device 104, after powering up, sends a preconfigured sequence to mobile device 102. For example, when the verification device 104 is bought into the NFC field of the mobile device 102, the verification device 104 restores power but the input mechanisms (e.g. keys or buttons or sensors) of the input device 206 are not yet powered. Next, the verification device 104 sends the mobile device 102 a sequence of bytes to request the mobile device 102 to enter the secure communication mode to accept encrypted data from the verification device 104. The mobile device 102 then sends the verification device 104 a corresponding sequence of bytes confirming that the secure communication mode is enabled and that it is ready to accept encrypted data. In at least some embodiments, data transmitted between the mobile device 102 and the verification device 104 need not be encrypted, or only portions of the data transmitted are encrypted.

After a secure connection has been established as described, the sensors, scanners, keys or buttons of the input device 106 are powered and ready to accept input from a user, such as a consumer performing an electronic transaction. In an embodiment, as the user provides his input, the input is converted to verification data, which is then encrypted and transmitted sequentially to the mobile device 102. For example, when the consumer presses the first digit of a 4-digit PIN, the input is converted into a digital representation and the encrypted data of first digit is transmitted to a mobile device. Subsequently, the remaining 3 digits are also entered and the corresponding data is transmitted to the mobile device. The mobile device is configured to receive the encrypted data sequentially, decrypts the data, and assembles the PIN. Similar principles apply when other types of input are provided. For example, a fingerprint pattern may be converted into blocks of digital data to be transmitted one block at a time.

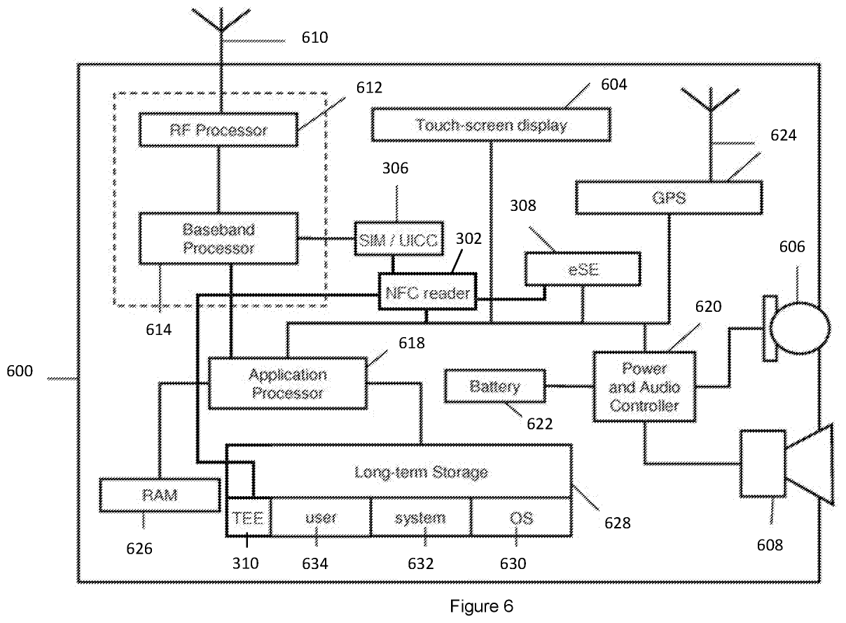

FIG. 3 shows a schematic block diagram illustrating possible data flows within a mobile device 102 according to an example embodiment. As described above, the verification data, e.g. PIN, password, or biometric data, is assembled at a NFC reader 302 of the mobile device 102 from the verification data transmitted from the verification device 104 (FIG. 1). The mobile device 102 is any suitable wireless computing device, such as a mobile phone, tablet, smartphone, laptop, or personal digital assistant (PDA) and includes an application program, also referred to as an app 304, to handle an electronic transaction. The app 304 is configured to generate a payment request message to be sent, e.g. via a wireless data connection, for processing. The app 304 is also configured to cancel the payment request if a security risk is identified, for example, if the mobile device 102 detects another passive NFC device different from the verification device 104. The verification data that is assembled is incorporated into the payment request message in a secure manner. For example, in one embodiment, the verification data is communicated to a universal integrated circuit card (UICC) 306 of the mobile device 102. In another embodiment, the verification data is communicated to an embedded security element (eSE) 308 of the mobile device 102. In another embodiment, the verification data is communicated to a trusted execution environment (TEE) 310 of the mobile device 102. In these embodiments, the NFC reader 302 communicates directly with each of the UICC 306, the eSE 308, and the TEE 310 and does not interact with the operating system of the mobile device 102. Each of the UICC 306, eSE 308 and TEE 310 has built-in security architecture to process the verification data while interacting with the operating system or a processor of the mobile device 102. Further payment data processing would be understood by a person of ordinary skill in this field and will not be elaborated herein. While FIG. 3 shows the UICC 306, the eSE 308, and the TEE 310, alternate embodiments may include one or more of these components to securely process the verification data. Moreover, for the sake of brevity, other components of the mobile device 102 are omitted from FIG. 3 and a brief description of such components is provided below with reference to FIG. 6.

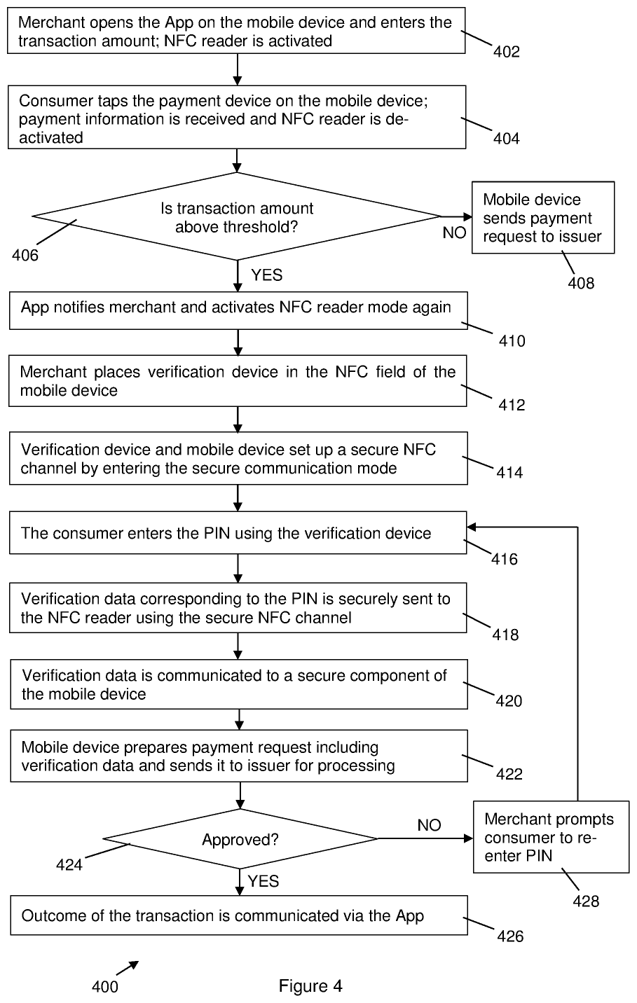

FIG. 4 shows a detailed flow chart 400 illustrating use of the system 100 of FIG. 1 in an electronic transaction according to an example embodiment. While this example is described in connection with PIN verification, it will be appreciated that similar principles apply to other types of user input, such as password or biometric input. At step 402, the merchant opens a POS app on the mobile device and enters the transaction amount. The NFC reader of the mobile device is activated such that an NFC field is generated. At step 404, the consumer taps the payment device (e.g. an NFC smartphone with a digital wallet or an NFC-enabled card) on the mobile device to make payment. Once that has been done, the mobile device receives payment information from the payment device and the NFC reader of the mobile device is de-activated. At step 406, the mobile device determines whether the transaction amount is above a preset threshold. If the transaction amount is below the preset threshold amount, for example, one-hundred dollars, at step 408, the mobile device sends a payment request to the issuer for processing.

If the transaction amount is above the preset threshold, at step 410, the app notifies the merchant and activates the NFC reader mode of the mobile device again. At step 412, the merchant places the verification device, e.g. in the form of a detachable NFC keypad as described above, in the NFC field of the mobile device for pairing. For example, if the verification device is integrated into the cover flap of the mobile device, the cover flap may be flipped to the back of the mobile device. At step 414, the verification device and the mobile device set up a secure NFC channel by entering the secure communication mode as described above. At step 416, the consumer enters the PIN using the verification device. At step 418, verification data corresponding to the PIN is securely transmitted to the NFC reader of the mobile device using the secure NFC channel as described above, and no storage of the verification data is made on the verification device. At step 420, the verification data is communicated to a secure component of the mobile device. At step 422, the mobile device prepares a payment request including the verification data processed by the secure component and sends it to the card issuer for processing. At step 424, the PIN is verified by the issuer which may approve or reject the request. At step 426, if the request is approved, the outcome of the transaction is communicated via the app of the mobile device. If the request is rejected due to an incorrect PIN, at step 428, the merchant can request the consumer to re-enter the PIN and the relevant steps are repeated.

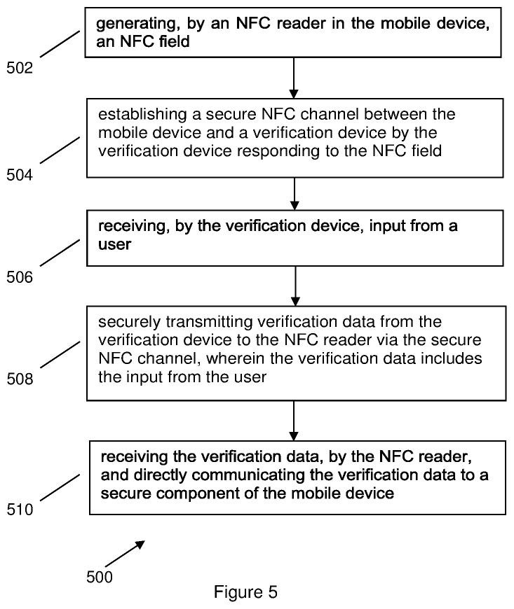

FIG. 5 shows a flow chart 500 illustrating a method for processing verification data by a mobile device according to an example embodiment. At step 502, an NFC reader in the mobile device generates an NFC field. At step 504, a secure NFC channel is established between the mobile device and a verification device by the verification device responding to the NFC field. At step 506, the verification device receives input from a user. At step 508, verification data is securely transmitted from the verification device to the NFC reader via the secure NFC channel. The verification data corresponds to the input from the user and includes the input from the user encoded within the verification data. At step 510, the NFC reader receives the verification data and securely communicates the verification data to a secure component of the mobile device.

As described, the mobile device and verification device are in an active-passive pairing and use secure NFC channels for communication. In at least some embodiments, the verification device is registered with the mobile device before the secure connection is made. The registration may be carried out by the acquirer, a service provider or the merchant. Moreover, the mobile device can terminate the secure connection if the mobile device detects a passive device different from the previously-registered verification device. These security measures can provide safeguards against potential security attacks.

The systems, devices, and methods as described in example embodiments can provide an effective solution to address security concerns when providing verification data to a mobile device. Consumer confidence and acceptance of the solution may be expected, as the card verification data is not entered via the user interface of operating system of the mobile device and therefore not shared with the operating system of the mobile device, or other components of the mobile device, prior to secure processing by one or more of the secure components of the mobile device. The solution is also relatively low cost and easy to implement, especially for merchants with low volumes or turnovers.

FIG. 6 shows a schematic of an example wireless computing device 600 that may be utilized to implement the mobile device 102 and possible data flows as illustrated and described with reference to FIG. 3.

The wireless device 600 comprises a touch-screen 604, a microphone 606, a speaker 608 and an antenna 610. The wireless device 600 is capable of being operated by a user to perform a variety of different functions, such as, for example, hosting a telephone call, sending an SMS message, browsing the Internet, sending an email and providing satellite navigation.

The wireless device 600 comprises hardware to perform communication functions (e.g. telephony, data communication), together with an application processor and corresponding support hardware to enable the wireless device 600 to have other functions, such as, messaging, Internet browsing, email functions and the like. The communication hardware is represented by a radio frequency (RF) processor 612 which provides an RF signal to the antenna 610 for the transmission of data signals, and the receipt therefrom. Additionally provided is a baseband processor 614, which provides signals to and receives signals from the RF Processor 612. The baseband processor 614 also interacts with a subscriber identity module (SIM) or universal integrated circuit card (UICC) 306, as is well known in the art. The communication subsystem enables the wireless device 600 to communicate via a number of different communication protocols including 3G, 4G, GSM, WiFi, Bluetooth™ and/or CDMA. The communication subsystem of the wireless device 600 is beyond the scope of the present invention.

The touch-screen 604 is controlled by an application processor 618. A power and audio controller 620 is provided to supply power from a battery 622 to the communication subsystem, the application processor 618, and the other hardware. The power and audio controller 620 also controls input from the microphone 606, and audio output via the speaker 608. Also provided is a global positioning system (GPS) antenna and associated receiver 624 which is controlled by the application processor 618 and is capable of receiving a GPS signal for use with a satellite navigation functionality of the wireless device 600.

In order for the application processor 618 to operate, various different types of memory are provided. Firstly, the wireless device 600 includes Random Access Memory (RAM) 626 connected to the application processor 618 into which data and program code can be written and read from at will. Code placed anywhere in RAM 626 can be executed by the application processor 618 from the RAM 626. RAM 626 represents a volatile memory of the wireless device 600.

Secondly, the wireless device 600 is provided with a long-term storage 628 connected to the application processor 618. The long-term storage 628 comprises multiple partitions, an operating system (OS) partition 630, a system partition 632 and a user partition 634. In at least some embodiments, the long-term storage 628 may also include a TEE 310. The long-term storage 628 represents a non-volatile memory of the wireless device 600.

In the present example, the OS partition 630 contains the firmware of the wireless device 600 which includes an operating system. Other computer programs may also be stored on the long-term storage 628, such as application programs (also referred to as apps), and the like. In particular, application programs which are mandatory to the wireless device 600, such as, in the case of a smartphone, communications applications and the like are typically stored in the system partition 632. The application programs stored on the system partition 632 would typically be those which are bundled with the wireless device 600 by the device manufacturer when the wireless device 600 is first sold.

Application programs which are added to the wireless device 600 by the user would usually be stored in the user partition 634.

The wireless device 600 is also provided with an NFC reader 302 in preferred embodiments, and the NFC reader 302 is connected to the application processor 618. An eSE 308 may also be provided in some embodiments. In at least some embodiments, direct connections are provided between the NFC reader 302 and the SIM/UICC 306, TEE 310 and eSE 308 where such components are present.

As stated, the representation of FIG. 6 is a schematic. In practice, the various functional components illustrated may be substituted into one and the same component. For example, the long-term storage 628 may comprise NAND flash, NOR flash, a hard disk drive or a combination of these. A suitable wireless device 600 may include additional components or fewer components that what is shown in the schematic.

It will be appreciated by a person or ordinary skill in the art that numerous variations and/or modifications may be made to the present invention as shown in the specific embodiments without departing from the spirit or scope of the invention as broadly described. The present embodiments are, therefore, to be considered in all respects to be illustrative and not restrictive.

What is claimed is:

1. A system for securely processing verification data, the system comprising:
a mobile device including an NFC reader capable of generating an NFC field; and
a verification device associated with the mobile device and responsive to the NFC field, wherein a secure NFC channel is established between the mobile device and the verification device;
wherein the verification device is configured to receive input from a user and transmit verification data to the mobile device via the secure NFC channel, wherein the verification data includes the input from the user; and
wherein the NFC reader of the mobile device is further configured to receive the verification data and directly communicate the verification data to a secure component of the mobile device.

2. The system as claimed in claim 1, wherein the secure component is a universal integrated circuit card (UICC) of the mobile device.

3. The system as claimed in claim 1, wherein the secure component is an embedded security element (eSE) of the mobile device

4. The system as claimed in claim 1, wherein the secure component is a trusted execution environment (TEE) of the mobile device.

5. The system as claimed in claim 1, wherein the verification data comprises cardholder verification data.

6. The system as claimed in claim 5, wherein the cardholder verification data comprises an alphanumeric string, and wherein the verification device is configured to transmit each element of the alphanumeric string sequentially to the mobile device.

7. The system as claimed in claim 5, wherein the cardholder verification data comprises biometric data, and wherein the verification device comprises a biometric sensor configured to receive a biometric input from the user.

8. The system as claimed in claim 1, wherein the verification device is configured to transmit the verification data to the mobile device directly without storing any of the verification data on the verification device.

9. The system as claimed in claim 1, wherein the verification device comprises a passive NFC device comprising:
a processor;
an NFC chip communicatively coupled to the processor; and
an input device communicatively coupled to the processor and configured to receive the input from the user.

10. A method of securely processing verification data by a mobile device, the method comprising:
generating, by an NFC reader in the mobile device, an NFC field;
establishing a secure NFC channel between the mobile device and a verification device by the verification device responding to the NFC field;
receiving, by the verification device, input from a user;
securely transmitting verification data from the verification device to the NFC reader via the secure NFC channel, wherein the verification data includes the input from the user; and
receiving the verification data, by the NFC reader, and directly communicating the verification data to a secure component of the mobile device.

11. The method as claimed in claim 10, wherein the secure component is a universal integrated circuit card (UICC) of the mobile device.

12. The method as claimed in claim 10, wherein the secure component is an embedded security element (eSE) of the mobile device.

13. The method as claimed in claim 10, wherein the secure component is a trusted execution environment (TEE) of the mobile device.

14. The method as claimed in claim 10, further comprising associating the verification device with the mobile device prior to establishing the secure NFC channel.

15. The method as claimed in claim 10, wherein the verification data comprises cardholder verification data.

16. The method as claimed in claim 15, wherein the cardholder verification data comprises an alphanumeric string, and wherein transmitting the verification data comprises transmitting each element of the alphanumeric string sequentially to the mobile device.

17. The method as claimed in claim 15, wherein the cardholder verification data comprises biometric data, and wherein receiving the input from the user comprises receiving a biometric input from the user.

18. The method as claimed in claim 10, wherein securely transmitting the verification data from the verification device to the mobile device comprises transmitting directly without storing any of the verification data on the verification device.

19. The method as claimed in claim 10, further comprising terminating the secure NFC channel upon the mobile device detecting an NFC device different from the verification device.
